(19) United States
(12) Patent Application Publication
(10) Pub. No.: US 2006/0142531 A1
(43) Pub. Date: Jun. 29, 2006

(54) Aliphatic sinterable thermoplastic polyurethanes and use thereof

(75) Inventors: Henricus Peerlings, Solingen (DE); Wolfgang Kaufhold, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/313,419

(22) Filed: Dec. 21, 2005

(30) Foreign Application Priority Data
Dec. 24, 2004 (DE) 102004062476.3

(51) Int. Cl. C08G 18/00

(52) U.S. Cl. 528/44

(57) ABSTRACT

The present invention relates to aliphatic, light-resistant, sinterable, thermoplastic polyurethanes which exhibit improved crease performance, with low fogging, good thermal resistance, agreeable tactile properties and good technical workability. This invention also relates to the preparation of heat-resistant, light resistant moldings and skins and, and to the preparation of skins by the powder-slush process from these thermoplastic polyurethanes.

### CROSS REFERENCE TO RELATED PATENT APPLICATION

The present patent application claims the right of priority under 35 U.S.C. §119 (a)-(d) of German Patent Application No. 10 2004 062 476.3, filed Dec. 24, 2004.

### BACKGROUND OF THE INVENTION

The present invention relates to aliphatic, light-resistant, sinterable, thermoplastic polyurethane molding compositions with improved creasing behavior, with low fogging, good thermal resistance, agreeable tactile properties and good technical workability, and also to the use thereof.

Thermoplastic polyurethanes (TPU) are of great technical significance on account of their good elastomeric properties and thermoplastic workability. An overview of the production, properties and applications of TPU is given in, for example, Kunststoff Handbuch [G. Becker, D. Braun], Volume 7, Polyurethane, Munich, Vienna, Carl Hanser Verlag, 1983.

TPU are generally synthesised from linear polyols (macrodiols) such as polyester diols, polyether diols or polycarbonate diols, organic diisocyanates and short-chain, generally difunctional alcohols (chain-extenders). They may be produced continuously or discontinuously. The most well-known production processes are the belt process (GB-A 1 057 018) and the extruder process (DE-A 19 64 834).

Synthesis of the thermoplastically workable polyurethane elastomers may be undertaken either in stepwise manner (i.e. prepolymer metering process), or by the simultaneous reaction of all the components in one stage (i.e. one-shot metering process).

In DE-A 19 927 967, DE-A 19 825 228 and EP-A 0 928 812, the use of plasticisers in TPUs is described for the application of sinterable TPU powders in the interior of automobiles by means of powder-slush processes.

In DE-A 10 050 495, DE-A 10 206 839 and EP-A 1 028 132, mixtures of certain chain-extenders and physical mixtures of TPUs based on various chain-extenders are described for powder-slush applications.

In DE-A 19 940 014, TPUs based on mixtures of aliphatic diisocyanates are described for powder-slush applications.

In the case where sinterable powders consisting of thermoplastic polyurethanes in the so-called powder-slush process are used, the problem increasing appears during the demolding of a slushed skin, due to the high crystallinity when the TPUs are HDI-based aliphatic TPUs. It is not possible for these creases folds to be removed, and thus, this results in a high-rate of rejection of these skins.

The object of the present invention was therefore to make thermoplastic, sinterable polyurethanes (TPUs) that show only slight creasing or no creasing behavior, while at the same time, only slight fogging or no fogging, good thermal stability, agreeable tactile properties and good technical workability. The TPUs that are known and described in the state of the art do not satisfy these requirements.

This object of the present invention was able to be achieved by means of TPUs having a special composition.

### SUMMARY OF THE INVENTION

The present invention relates to light-resistant, sinterable, aliphatic, thermoplastic polyurethanes. These TPUs comprise the reaction product of:

a) an isocyanate component consisting of
a1) from 75 mol % to 100 mol % 1,6-hexamethylene diisocyanate,
and
a2) from 0 mol % to 25 mol % of a (cyclo)aliphatic diisocyanate or of a mixture of (cyclo)aliphatic diisocyanates, with the proviso that this aliphatic diisocyanate excludes 1,6-hexamethylene diisocyanate,
in which the sum of the mol % of a1) and the mol % of a2) totals 100 mol % of a);

with

b) a chain-extending component consisting of:
b1) from 75 mol % to 100 mol % of a chain-extender selected from the group consisting of: 1,2-ethanediol, 1,3-propanediol, 1,4-butanediol, 1,5-pentanediol, 1,6-hexanediol, 1,10-decanediol, 1,12-dodecanediol, diethylene glycol, dipropylene glycol, terephthalic acid bis(ethylene glycol), terephthalic acid bis(1,4-butanediol), 1,4-di(β-hydroxyethyl)hydroquinone and 1,4-di(β-hydroxyethyl)bisphenol A,
and
b2) from 0 mol % to 25 mol % of a chain-extender with a molecular weight from 60 g/mol to 400 g/mol or of a mixture of chain-extenders, with the proviso that chain-extender b2) is different than chain-extender b1),
in which the sum of the mol % of b1) and the mol % of b2) totals 100 mol % of b);

wherein the arithmetic sum of the mol percentages of a2) and b2) totals from 2 mol % to 28 mol %;

and

c) at least one component having a number-average molecular weight of from 450 g/mol to 10,000 g/mol and, on average, at least 1.8 to at most 3.0 Zerewitinoff-active hydrogen atoms;

wherein the ratio of the isocyanate groups in component a), to the groups that are reactive with isocyanate groups in components b) and c) and optionally h), ranges from 0.9:1 to 1.1:1;

in the presence of:

d) from 1 wt. % to 30 wt. %, based on 100 wt. % of the thermoplastic polyurethane, of one or more plasticizers having a number-average molecular weight from 200 g/mol to 10,000 g/mol;

e) optionally, one or more catalysts;

f) from 0.1 wt. % to 10 wt. %, based on 100 wt. % of the thermoplastic polyurethane, of one or more light stabilizers,

g) optionally, one or more additives and/or auxiliary substances, and

h) optionally, one or more chain-terminators.

These sinterable, light-resistant TPUs of the invention exhibit no or only slight creasing behavior, no or only low fogging, good thermal stability, agreeable tactile properties and good workability.

### DETAILED DESCRIPTION OF THE INVENTION

Component a1) of the present invention is 1,6-hexamethylene diisocyanate.

In accordance with the present invention, suitable compounds to be used as organic diisocyanates a2) include the following aliphatic diisocyanates: ethylene diisocyanate, 1,4-tetramethylene diisocyanate, 1,12-dodecane diisocyanate; cycloaliphatic diisocyanates such as isophorone diisocyanate, 1,4-cyclohexane diisocyanate, 1-methyl-2,4-cyclohexane diisocyanate, and 1-methyl-2,6-cyclohexane diisocyanate and also the corresponding mixtures of isomers, 4,4′-dicyclohexylmethane diisocyanate, 2,4′-dicyclohexylmethane diisocyanate and 2,2′-dicyclohexylmethane diisocyanate and also the corresponding mixtures of isomers. It is preferred that component a2) comprises 1,4-cyclohexane diisocyanate, isophorone diisocyanate and/or dicyclohexylmethane diisocyanate. The above identified diisocyanates may be suitable either individually or in the form of mixtures with one another. They may also be used together with up to 15 mol % (based on 100 mol % of a) the isocyanate component) of a polyisocyanate. The maximum amount of polyisocyanate which may be added is that from a product arises that is still thermoplastically workable. Component a2) excludes 1,6-hexamethylene diisocyanate.

Suitable compounds to be used as chain-extender b1) in accordance with the present invention include, for example, a diol which is selected from the group consisting of: 1,2-ethanediol, 1,3-propanediol, 1,4-butanediol, 1,5-pentanediol, 1,6-hexanediol, 1,10-decanediol, 1,12-dodecanediol, diethylene glycol, dipropylene glycol, terephthalic acid bis(ethylene glycol), terephthalic acid bis(1,4-butanediol), 1,4-di(β-hydroxyethyl)hydroquinone and 1,4-di(β-hydroxyethyl)bisphenol A. Preferred diols for component b1) include, for example, 1,2-ethanediol, 1,3-propanediol, 1,4-butanediol, 1,5-pentanediol, 1,6-hexanediol, 1,10-decanediol, 1,12-dodecanediol, diethylene glycol and dipropylene glycol is preferably employed. Also suitable to be used as b1), however, are diesters of terephthalic acid with glycols having 2 to 4 carbon atoms such as, for example, terephthalic acid bis(ethylene glycol) and terephthalic acid bis(1,4-butanediol), hydroxyalkylene ethers of hydroquinone such as, for example, 1,4-di(β-hydroxyethyl)hydroquinone, and ethoxylated bisphenols such as, for example, 1,4-di(β-hydroxyethyl)bisphenol A.

Suitable compounds to be used as chain-extending agent b2) have a molecular weight from 60 to 400. These compounds possess, on average, preferably from about 1.8 to about 3.0 Zerewitinoff-active hydrogen atoms. These Zerewitinoff-active hydrogen atoms are to be understood to include compounds containing amino groups, thiol groups and/or carboxyl groups, as well as compounds which contain two to three, and preferably two, hydroxyl groups.

Examples of suitable compounds to be used as chain extender b2) include one or more compounds that may or may not correspond to those identified above as being suitable for chain-extender b1), with the proviso that b2) is different than b1). The chain extenders b2) is/are preferably selected from the group consisting of the aliphatic diols which contain from 2 to 14 carbon atoms such as, for example, ethanediol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane and neopentyl glycol. Also suitable to be used as chain extenders b2) are, however, the diesters of terephthalic acid with glycols which have from 2 to 4 carbon atoms such as, for example, terephthalic acid bis(ethylene glycol) and terephthalic acid bis(1,4-butanediol), the hydroxyalkylene ethers of hydroquinone such as, for example, 1,4-di(β-hydroxyethyl)hydroquinone, the ethoxylated bisphenols such as, for example, 1,4-di(β-hydroxyethyl)bisphenol A, the (cyclo)aliphatic diamines such as, for example, isophoronediamine, ethylenediamine, 1,2-propylenediamine, 1,3-propylenediamine, N-methylpropylene-1,3-diamine, N,N′-dimethylethylene-diamine, the aromatic diamines such as, for example, 2,4-toluenediamine, 2,6-toluenediamine, 3,5-diethyl-2,4-toluenediamine and 3,5-diethyl-2,6-toluenediamine, and primary mono-, di-, tri- or tetraalkyl-substituted 4,4′-diaminodiphenylmethanes. In particularly preferred embodiment, the chain-extenders b2) are selected from the group consisting of ethanediol, 1,4-butanediol, 1,6-hexanediol, 1,4-dimethanolcyclohexane, 1,4-di(β-hydroxyethyl)hydroquinone, 1,4-di(P-hydroxyethyl)bisphenol A and mixtures thereof. In addition, relatively small quantities of triols may also be added.

Suitable compounds to be used as component c) in accordance with the present invention include those with, on average, at least about 1.8 to at most about 3.0 Zerewitinoff-active hydrogen atoms and which have a number-average molecular weight \overline{M}ₙ of from about 450 to about 10,000. Due to the manner of producing such compounds, these frequently contain small quantities of non-linear compounds. Accordingly, these may frequently be described as “substantially linear polyols”. Preferred compounds for component c) include polyester diols, polyether diols, polycarbonate diols or mixtures of these.

In addition, the compounds which are suitable as component c) include those which exhibit amino groups, thiol groups and/or carboxyl groups, as well as compounds which exhibit, preferably two to three, and more preferably two, hydroxyl groups. Compounds which contain hydroxyl groups are preferred, especially those having number-average molecular weights \overline{M}ₙ from 450 to 6000, and more preferably those having a number-average molecular weight \overline{M}ₙ from 600 to 4500. Such compounds include, for example, polyesters, polyethers and polycarbonates containing hydroxyl groups, and also polyester amides, are particularly preferred.

Suitable polyether diols include those which may be prepared by reacting one or more alkylene oxides containing 2 to 4 carbon atoms in the alkylene residue with a suitable starter molecule that contains two active hydrogen atoms in bonded form. By way of suitable alkylene oxides, the following compounds, for example, may be named: ethylene oxide, 1,2-propylene oxide, epichlorohydrin and 1,2-butylene oxide and 2,3-butylene oxide. Ethylene oxide, propylene oxide and mixtures of 1,2-propylene oxide and ethylene oxide preferred. The alkylene oxides may be used individually, alternately in succession, or in the form of mixtures. Suitable starter molecules include, for example, the following compounds: water, amino alcohols such as N-alkyl diethanolamines such as, for example N-methyl diethanolamine, and diols such as ethylene glycol, 1,3-propylene glycol, 1,4-butanediol and 1,6-hexanediol. Optionally, mixtures of suitable starter molecules may also be employed. Suitable polyether polyols are, furthermore, the hydroxyl-group-containing polymerization products of tetrahydrofuran. Trifunctional polyethers in proportions of from 0 wt. % to 30 wt. %, based on 100 wt. % of the bifunctional polyethers, may also be employed. The maximum quantity of these trifunctional polyethers which may be used is that quantity from which a product arises that is still thermoplastically workable. The substantially linear polyether diols preferably possess number-average molecular weights \overline{M}ₙ from 450 to 6000. They are suitable both individually and in the form of mixtures with one another.

Suitable polyester diols include, for example, those which are prepared from dicarboxylic acids having 2 to 12 carbon atoms, preferably 4 to 6 carbon atoms, and polyhydric alcohols. By way of suitable dicarboxylic acids, the following, for example, may be mentioned: aliphatic dicarboxylic acids such as succinic acid, glutaric acid, adipic acid, suberic acid, azelaic acid and sebacic acid, or aromatic dicarboxylic acids such as phthalic acid, isophthalic acid and terephthalic acid. The dicarboxylic acids may be used individually or in the form of mixtures such as, for example, in the form of a mixture of succinic, glutaric and adipic acids. For the purpose of preparing the polyester diols it may be advantageous in appropriate circumstances to use, instead of the dicarboxylic acids, the corresponding dicarboxylic acid derivatives such as, for example, carboxylic acid diesters having 1 to 4 carbon atoms in the alcohol residue, carboxylic acid anhydrides or carboxylic acid chlorides. Examples of suitable polyhydric alcohols for preparation of the polyester diols include the glycols which have from 2 to 10, preferably from 2 to 6 carbon atoms. Some examples include ethylene glycol, diethylene glycol, 1,4-butanediol, 1,5-pentanediol, 1,6-hexanediol, 1,10-decanediol, 2,2-dimethyl-1,3-propanediol, 1,3-propanediol or dipropylene glycol. Depending on the desired properties, the polyhydric alcohols may be used either individually or in a mixture with one another. Also suitable are esters of carbonic acid with the above named diols, and in particular, those with 4 to 6 carbon atoms, such as 1,4-butanediol or 1,6-hexanediol, condensation products of ω-hydroxycarboxylic acids, such as ω-hydroxycaproic acid, or polymerization products of lactones such as, for example, optionally substituted ω-caprolactones. It is preferred that the polyester diols used herein are ethanediol-polyadipates, 1,4-butanediol polyadipates, ethanediol-1,4-butanediol polyadipates, 1,6-hexanediol neopentyl glycol polyadipates, 1,6-hexanediol-1,4-butanediol polyadipates and polycaprolactones. The polyester diols possess number-average molecular weights \overline{M}ₙ of from 450 to 10,000 and may be suitable herein either individually or in the form of mixtures with one another.

Monofunctional compounds that react with isocyanates may also be employed in the TPUs of the invention in proportions of up to 2 wt. %, based on 100 wt. % of TPU. These monofinctional compounds are typically referred to as chain-terminators, i.e. component h) herein. Suitable monofunctional compounds include, for example, monoamines such as butylamine and dibutylamine, octylamine, stearylamine, N-methylstearylamine, pyrrolidine, piperidine or cyclohexylamine. Also suitable are monoalcohols such as, for example, butanol, 2-ethylhexanol, octanol, dodecanol, stearyl alcohol, the various amyl alcohols, cyclohexanol and ethylene glycol monomethyl ether.

Suitable compounds to be used as component d), i.e. the plasticizers, include compounds such as those described by, for example, M. Szycher in M. Szycher's Handbook of Polyurethanes, 1999, CRC Press, pages 8-28 to 8-30. Such compounds include phosphates, carboxylates (such as, for example, phthalates, adipates, sebacates), silicones and alkylsulfonic acid esters. Due to the fact that plasticizers which have low molecular weight contribute to fogging, the number-average molecular weight \overline{M}ₙ of the plasticizer should amount to more than 200 g/mol.

The relative quantities of the Zerewitinoff-active hydrogen containing compounds are preferably so chosen that the ratio of the sum of the isocyanate groups to the sum of the Zerewitinoff-active hydrogen atoms ranges from 0.9:1 to 1.1:1.

The thermoplastic polyurethanes according to the invention may optionally contain auxiliary substances and additives, i.e. component g), preferably in amounts of up to 10 wt. %, based on 100 wt. % of the TPU, in which these are the conventional auxiliary substances and additives. Typical auxiliary substances and additives are lubricants and mold-release agents, such as fatty-acid esters, the metallic soaps thereof, fatty-acid amides, fatty-acid ester amides and silicone compounds, anti-blocking agents, inhibitors, stabilizers for countering hydrolysis, heat and discoloration, dyestuffs, pigments, inorganic and/or organic fillers, substances having a fungistatic and bacteriostatic action, and mixtures thereof.

More detailed specifics concerning the named auxiliary substances and additives can be found in the specialized literature such as, for example, from the monograph by J. H. Saunders and K. C. Frisch entitled High Polymers, Volume XVI, Polyurethanes, Parts 1 and 2, Verlag Interscience Publishers 1962 and 1964, from the Taschenbuch för Kunststoff-Additive by R. Gächter and H. Müller (Hanser Verlag Munich 1990), or from DE-A 29 01 774, the disclosure of which is herein incorporated by reference.

Suitable materials to be used as light stabilisers, i.e. component f) herein, include the known UV stabilizers, anti-oxidants and/or HALS compounds all of which are preferably employed herein. More detailed particulars can be gathered from the specialized literature and are described, for example, in Plastics Additives Handbook, 2001, 5^{th} Edition, Carl Hanser Verlag, Munich.

Further admixtures that can be worked into the TPU include thermoplastics such as, for example, polycarbonates and acrylonitrile/butadiene/styrene terpolymers, and in particular, ABS. It may also be useful to include other elastomers such as, for example, rubber, ethylene/vinyl-acetate copolymers, styrene/butadiene copolymers and also other TPUs.

Suitable catalysts to be used as component e) herein, include the conventional tertiary amines which known from the state of the art, such as, for example, triethylamine, dimethylcyclohexylamine, N-methylmorpholine, N,N′-dimethylpiperazine, 2-(dimethylaminoethoxy)ethanol, diazabicyclo[2,2,2]octane and similar as well as, in particular, organic metallic compounds such as titanic acid esters, iron compounds or tin compounds, such as tin diacetate, tin dioctoate, tin dilaurate or the dialkyltin salts of aliphatic carboxylic acids, such as dibutyltin diacetate or dibutyltin dilaurate or similar. Preferred catalysts are the organic metallic compounds, and in particular titanic acid esters, iron compounds, tin compounds, zirconium compounds and bismuth compounds. The total quantity of catalysts in the TPU according to the invention preferentially amounts to, as a rule, from 0 wt. % to 5 wt. %, preferably from 0 wt. % to 2 wt. %, based on 100 wt. % of TPU.

The addition of the auxiliary substances and additives may be mixed into the TPU either during the production process and/or during the course of additional compounding. In order to subsequently obtain a sinterable molding composition, the TPU is preferably finely ground under the influence of liquid nitrogen. The sinterable product, in this case, preferably has an average particle-size distribution from 50 μm to 800 μm.

The TPUs according to the present invention are preferably employed in the powder-slush process.

The TPUs according to the present invention are preferably employed for the purpose of producing heat-resistant, light-resistant moldings and skins which exhibit slight fogging and good creasing behavior.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

The following components were used in the examples:

PE 225B: a polyester diol having a molecular weight of Mₙ=2250 g/mol; commercially available from Bayer MaterialScience AG

Acclaim 2220N: a polyether diol having a molecular weight of Mₙ=2250 g/mol and containing a mixture of C₃ and C₂ alkylene units; commercially available from Bayer MaterialScience AG

HDI: 1,6-hexamethylene diisocyanate

IPDI: isophorone diisocyanate

HDO: 1,6-hexanediol

BDO: 1,4-butanediol

Plasticizer A: bisphenol A diphenyl phosphate; commercially available as Reofos BAPP from Great Lakes Corp.; molecular weight: >693

Plasticizer B: dimethyl phthalate; molecular weight: 194

Irganox 1010: an antioxidant, commercially available from Speciality Chemicals GmbH

Tinuvin 622: HALS stabilizer, commercially available from Ciba Speciality Chemicals GmbH

Tinuvin 234: a light stabilizer based on a benzotriazole, commercially available from Ciba Speciality Chemicals GmbH

EBS: ethylene-bis-stearylamide

Elftex 435: carbon black, commercially available from Cabot Corp.

DBTL: dibutyltin dilaurate, a catalyst

General Description of the Production of the TPU:

A mixture of 368 g PE225B, 160 g Acclaim 2220N, x g HDO and y g BDO and z g plasticizer with 0.5 wt. % Irganox 1010 (based on 100 wt. % of the TPU), and approximately 60 ppm DBTL (based on 100 wt. % of polyol c)) were heated up to 130° C., and subjected to agitation with a blade agitator at a speed of 500 revolutions per minute (rpm), after which o g HDI and p g IPDI were added. Subsequently, agitation was effected up to the maximum possible rise in viscosity, and then the resultant TPU was poured out. Finally, the material was subjected to thermal aftertreatment for 30 min at 80° C., and was subsequently granulated. The precise formulations (i.e. the data relating to the variables x, y, z, o and p) is set forth in Table 1.

TABLE 1
Formulations

| | | x HDO | y BDO | z Plasticiser | o HDI | p IPDI |
|---|---|---|---|---|---|---|
| Example | Type of example | [g] | [g] | [g] | [g] | [g] |
| 1 | comparison | 68 | 0 | 0 | 134 | 0 |
| 2 | comparison | 68 | 0 | 313 Plasticizer A (30 | 134 | 0 |
| | | | | wt. %) | | |
| 3 | comparison | 68 | 0 | 313 Plasticizer B (30 | 134 | 0 |
| | | | | wt. %) | | |
| 4 | comparison | 58 (90 mol %) | 8 (10 mol %) | 0 | 135 | 0 |
| 5 | comparison | 48 (80 mol %) | 16 (20 mol %) | 0 | 133 | 0 |
| 6 | comparison | 68 | 0 | 0 | 121 (90 mol %) | 18 (10 mol %) |
| 7 | comparison | 68 | 0 | 0 | 107 (80 mol %) | 35 (20 mol %) |
| 8 | comparison | 68 | 0 | 0 | 94 (70 mol %) | 53 (30 mol %) |
| 9 | according to the invention | 58 (90 mol %) | 8 (10 mol%) | 83 Plasticizer A (10 wt. %) | 135 | 0 |
| 10 | according to the invention | 68 | 0 | 82 Plasticizer A (10 wt. %) | 121 (90 mol %) | 18 (10 mol %) |
| 11 | according to the invention | 58 (90 mol %) | 8 (10 mol %) | 23 Plasticizer A (3 wt. %) | 135 | 0 |
| 12 | according to the invention | 58 (90 mol %) | 8 (10 mol %) | 81 Plasticizer A (10 wt. %) | 128 (95 mol %) | 9 (5 mol %) |

The following were added to the TPU granulate produced in accordance with the general description above, Tinuvin 234, Tinuvin 622, and EBS (each in an amount of 0.5 wt. %, based on 100 wt. % of TPU) and Elftex 435, i.e. carbon black, (in an amount of 2 wt. %, based on 100 wt. % of TPU), and extrusion was effected in an extruder of the type DSE 25, 4 Z, 360 Nm. The extruder had the following structure:
1. a cold feed zone with conveying elements,
2. a first heating zone (165° C.) with a first kneading zone,
3. a second heating zone (175° C.) with conveying elements and a second kneading zone,
4. a third heating zone (180° C.) with a kneading zone, conveying elements and vacuum degassing,
5. a crosshead die (185° C.) and a nozzle (180° C.),
   with a conveying capacity of 10 kg/h at a speed of 220 rpm. The extruded mixture was subsequently reworked into granulate with a strand pelletizer.

Grinding of the compounded granulate that was produced was effected with a mill manufactured by Netzsch-Condux, type CUM100, at a grinding frequency of 21 000 rpm. The granulate was cooled under the influence of liquid nitrogen and was uniformly fed into the mill. The finished powder was subsequently dried in a drying cabinet (for 2 hours, at 90° C.). The average particle-size distribution amounted to 50 μm to 500 μm.

Then, the dried powder was charged into a tilting powder box. A grained metal plate made of nickel that had been preheated to 240° C. was clamped onto the powder box and was tilted several times, such that the powder was uniformly sinter-fused onto the hot plate. Subsequently, the grained plate with the sinter-fused TPU was annealed in an oven for one minute at 240° C. Subsequently, the plate was cooled, and the grained TPU skin was able to be demolded.

Determination of the Thermal Stability:

The thermal stability was ascertained by storage of the slushed skin, which was suspended in a circulating-air drying cabinet at 120° C. (with ±2° C. tolerance), over a period of 500 hours. After storage, a check was made to determined whether the material shows a fusing/gleaming of the grained side.

Determination of the Technical Workability:

In the course of extrusion and grinding, attention was paid to the technical workability. In this sense, the feed behavior of the TPU in the extruder during the course of re-extrusion, or the grinding behaviour were, for example, very critically observed. Any problems arising in the course of grinding were manifested mainly by, for example, clogging of the mill, excessive coarse portions in the powder, or incipient melting of the material in the mill.

Determination of the Creasing Behavior:

The creasing behavior of the finished TPU skin was determined by means of a qualitative assessment with respect to the slushed skin.

The creasing behavior was assessed by means of a folding of the skin, and subsequent qualitative assessment of the resulting kinks in the skin.

Determination of the Fogging Behavior:

For the determination of fogging, a quantity of condensate according to DIN 75201 (for 16 hours at 120° C.) was determined.

The results of these assessments are set forth in Table 2.

TABLE 2
Results

| | | High- | Techni- | Fogging | |
|---|---|---|---|---|---|
| | | temper- | cal | (condensate | |
| Ex- | Type of | ature | work- | quantity | Crease |
| ample | example | storage | ability | in mg) | performance |
| 1 | comparison | no fusing | good | 3.0 | poor |
| 2 | comparison | no fusing | poor | 4.4 | good |
| 3 | comparison | no fusing | poor | 32 | good |
| 4 | comparison | no fusing | good | 3.7 | poor |
| 5 | comparison | no fusing | good | 3.4 | poor |
| 6 | comparison | no fusing | good | 2.9 | poor |
| 7 | comparison | no fusing | good | 2.6 | Poor |
| 8 | comparison | fusing | poor | 3.6 | Good |
| 9 | according | no fusing | good | 4.0 | Good |
| | to the | | | | |
| | invention | | | | |
| 10 | according | no fusing | good | 2.3 | Good |
| | to the | | | | |
| | invention | | | | |
| 11 | according | no fusing | good | 2.0 | Good |
| | to the | | | | |
| | invention | | | | |
| 12 | according | no fusing | good | 2.7 | Good |
| | to the | | | | |
| | invention | | | | |

In comparative Example 1 a TPU formulation according to the state of the art was produced and examined. The creasing behavior is inadequate.

In comparative Examples 2 and 3, plasticizers according to the state of the art were employed. Although the creasing behavior is adequate, in Comparative Example 3 the fogging value was too high. In the course of cold grinding there were considerable technical problems with both Comparative Examples 2 and 3, due to clogging of the mill and agglutination of the powder, as well as fusing in the mill.

In Comparative Examples 4 and 5, the crease behavior was poor.

In Comparative Examples 6 to 8, a good crease behavior was achieved only in Comparative Example 8. However, the TPU from Comparative Example 8 began to melt during the course of high-temperature storage, and its technical workability was inadequate. Comparative Examples 6 and 7 exhibited an inadequate crease behavior.

Examples 9 to 12, which are representative of the present invention, illustrate that by virtue of combinations of plasticizers, chain-extenders and/or diisocyanates, as required by the present invention, TPU can be produced that satisfy all the requirements with regard to fusing behavior, technical workability, fogging and, most importantly, crease behavior.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A light-resistant, sinterable, aliphatic, thermoplastic polyurethane comprising the reaction product of:
a) an isocyanate component consisting of:
a1) from 75 mol % to 100 mol % of 1,6-hexamethylene diisocyanate,
and
a2) from 0 mol % to 25 mol % of a (cyclo)aliphatic diisocyanate or of a mixture of (cyclo)aliphatic diisocyanates, with the proviso that said aliphatic diisocyanates do not include 1,6-hexamethylene diisocyanate,
wherein the sum of a1) and a2) totals 100 mol % of a);
with
b) a chain-extending component consisting of:
b1) from 75 mol % to 100 mol % of a chain-extender selected from the group consisting of: 1,2-ethanediol, 1,3-propanediol, 1,4-butanediol, 1,5-pentanediol, 1,6-hexanediol, 1,10-decanediol, 1,12-dodecanediol, diethylene glycol, dipropylene glycol, terephthalic acid bis(ethylene glycol), terephthalic acid bis(1,4-butanediol), 1,4-di(β-hydroxyethyl)hydroquinone and 1,4-di(β-hydroxyethyl)bisphenol A,
and
b2) from 0 mol % to 25 mol % of a chain-extender having a molecular weight from 60 to 400 or a mixture thereof,
with the proviso that chain-extender b2) is different than chain-extender b1), and the sum of b1) and b2) totals 100 mol % of b);
wherein the arithmetic sum of the percentages of a2) and b2) totals from 2 mol % to 28 mol %;
and
c) at least one component having a number-average molecular weight of from 450 g/mol to 10,000 g/mol and, on average, at least 1.8 to at most 3.0 Zerewitinoff-active hydrogen atoms,
wherein the ratio of the isocyanate groups of a) to the groups of b), c) and optionally h) that are reactive with isocyanate ranges from 0.9:1 to 1.1:1; in the presence of
d) from 1 wt. % to 30 wt. %, based on 100 wt. % of the thermoplastic polyurethane, of one or more plasticizers having a number-average molecular weight from 200 g/mol to 10,000 g/mol,
e) optionally one or more catalysts,
f) from 0.1 wt. % to 10 wt. %, based on 100 wt. % of the thermoplastic polyurethane, of one or more light stabilizers,
g) optionally, one or more additives and/or auxiliary substances,
and
h) optionally, one or more chain-terminators.

2. The thermoplastic polyurethane of claim 1, wherein a1) comprises 1,6-hexamethylene diisocyanate, and a2) comprises isophorone diisocyanate.

3. The thermoplastic polyurethane of claim 2, wherein a1) is present in an amount of from 90 to 100 mol % and a2) is present in an amount of from 0 to 10 mol %.

4. The thermoplastic polyurethane of claim 1, wherein b1) comprises 1,6-hexanediol and b2) comprises 1,4-butanediol.

5. The thermoplastic polyurethane of claim 4, wherein b1) is present in an amount of from 90 to 100 mol % and b2) is present in an amount of from 0 to 10 mol %.

6. The thermoplastic polyurethane of claim 1, wherein c) comprises a polyester diol, a polyether diol or a mixture thereof.
